(19) United States
(12) Patent Application Publication
(10) Pub. No.: US 2001/0014250 A1
(43) Pub. Date: Aug. 16, 2001

(54) Insert structure with dual function

(75) Inventors: David D. Plummer, Hudson, WI (US); Geoffrey G. Bradt, Hudson, WI (US)

Correspondence Address: MERCHANT & GOULD, P O BOX 2903, MINNEAPOLIS, MN, 55402-0903, US

(73) Assignee: Andersen Corporation, Bayport, MN

(21) Appl. No.: 09/825,914

(22) Filed: Apr. 4, 2001

Related U.S. Application Data
(62) Division of application No. 09/301,469, filed on Apr. 28, 1999.

(51) Int. Cl. F16B 7/00; F16B 12/36; F16B 13/00

(52) U.S. Cl. 403/295

(57) ABSTRACT

A hollow profile insert or key can be used to form structural joints. In forming the joint, the insert or key is inserted into open ends of two or more hollow members, where the members are hollow at least in the joint forming area. An adhesive is then applied to the interface between the insert or key and each hollow member. The insert is engineered with channels and recessed adhesive accumulation areas or adhesive pans such that the adhesive accumulates only at a location at the recessed area, in a bonding location with the member, providing significant structural integrity to the joint. The insert can be configured to include either an external hinge pin insert aperture that is configured to accept a hinge pin or a support wheel support wheel aperture and a support wheel located therein.

### RELATED APPLICATION

This application is a §1.53(b) divisional of U.S. Ser. No. 09/301,469, filed Apr. 28, 1999, which is expressly incorporated by reference herein.

### TECHNICAL FIELD

The invention relates to assembly structures and methods adapted to adhesively join adjacent hollow members. The invention involves forming a joint between hollow members in which the joint can be made at an angle between the members that can vary from an acute angle of less than 5° to a straight angle approximating 180° (including outside angles greater than 180° such as a 270° angle). The structural joint is adequate for maintaining the integrity of the resulting assembly without need of secondary metal, plastic or other conventional fastener components that provide rigidity through mechanical association through the members. The invention further involves the cooperation between liquid adhesives that chemically cure (crosslink) or cool and solidify in an adhesive bond, with specially adapted assembly insert structures.

### BACKGROUND

Joinery of materials to form a reliable assembly structure is an important technology having a variety of embodiments. Solid, wooden and metal members are often joined using specially milled or shaped interactive structures. Such structures are often reinforced with fasteners that are introduced into the assembly through milled passages or openings. Such joints are often reinforced using welding or adhesive processes that provide added strength at the interface between the structural members. Such joinery techniques have a long history in the woodworking and metal fabricating arts.

Joining hollow members made of metal, thermoplastic, composites, wood, etc. has also evolved over the years. Hollow members can be joined at the periphery of the hollow space using welding, adhesive, or fastener technology. Such fasteners can include bolt structures, screw fasteners, nails, staples, or other joinery components.

The use of a key or insert structure in which a joint between hollow members is reinforced by the insertion of a portion of the key or insert into each hollow structure is known. The joint is usually formed by enclosing the key or insert entirely inside the members which come into contact at a joint line.

The industry recognizes that such inserts or keys can be held in place solely by mechanical forces arising from the interaction between the insert or key and the internal parts of the hollow member. The surface of the key and the internal structure of the hollow members can be raised or ribbed in appropriate locations such that the interaction between the key and the hollow member locks the key in place. Further, the prior art shows the conventional use of metal or other fastener components in conjunction with key or insert structures for forming secured joints. Such structures are shown in Rafeld, U.S. Pat. No. 4,145,150 and Bubley, U.S. Pat. No. 4,452,138. The prior art also recognizes that such joints, particularly corner joints using a corner key or corner insert, can be used to join hollow members at a 90° angle, can also include a sealant in combination with the insert or key in the corner assembly. The sealant typically prevents the penetration of water or atmospheric moisture into the joint or into the hollow member to ensure window clarity and integrity.

The use of adhesives to secure the insert or key in the joint has also been described in the prior art. However, prior art suggests that there are significant problems in applying adhesives to the interface between the key and the hollow member. For example, the prior art provides no method to ensure the adhesive accumulates in the optimum location for high strength joinery. Secondly, the prior art does not provide a self-regulating mode for ensuring that the correct weight or volume of adhesives are introduced into the joint. Further, the prior art fails to provide a method to ensure that the adhesive, after injection into the correct location, does not migrate to a non-bonding location. The prior art shows relatively complex modes for applying one or two part adhesive compositions involving applying a primer or hardener to a part prior to assembly that ensures hardening of the adhesive after assembly. Further, the adhesive prior art often suggests the necessity for the use of a fastener such as a screw, staple or nail to ensure joint integrity during the curing stage of the adhesive or to ensure that the adhesive/fastener joint is of sufficient integrity to satisfy mechanical loads during assembly, installation and useful life.

### SUMMARY OF THE INVENTION

A hollow profile insert or key can be used to form structural joints. In forming the joint, the insert or key is inserted into open ends of two or more hollow members, where the members are hollow at least in the joint forming area. An adhesive is then applied to the interface between the insert or key and each hollow member.

The insert is engineered with channels and recessed adhesive accumulation areas or adhesive pans such that the adhesive accumulates only at a location at the recessed area, in a bonding location with the member, providing significant structural integrity to the joint. The insert or key can be made self-regulating such that the joint will accept only a required volume of adhesive or the correct volume adhesive can be easily and accurately applied by flowing the adhesive only for a fixed period of time, typically less than 60 seconds, preferable 15 seconds or less provides 5 to 50 milliliters or 5 to 50 grams of adhesive, preferably 10 to 25 milliliters or 10 to 25 grams of adhesive. Such linear or corner, adhesive bonded and secure, joints have sufficient structural integrity such that additional fastener components are not needed. The adhesive assembled joints are sufficiently strong to survive manufacture, installation and a long useful life.

In this application a hollow member is hollow at a minimum at the joining area in order to fully receive the insert and the insert is held entirely within the joint and cannot be viewed after assembly. A pan is a recessed area preferably formed in the insert with minimal depth, formed in the insert to closely associate with a portion of the member to form a volume for introduction of the adhesive. The pan is engineered to increase the surface area of the adhesive bond between the pan and the member. An inlet port is an opening that is engineered to permit conventional application of an adhesive into the joint, channels and pans. A channel is a fluid competent guide between an inlet port and a pan.

In accordance with a preferred embodiment of the invention, there is provided a joint structure including an inlet port that also includes a first linear member and a second linear member, where each linear member defines hollow interiors at least at the ends of the linear members. An insert can join the linear members, proximate to the inlet port in the joint structure, the insert defining at least one channel proximate the inlet port, at least one pan formed in the insert associated with the first linear member, and at least one pan formed in the insert associated with the second linear member. An adhesive forms a structural bond between the insert and the linear members at the channel, which is configured to permit flow of adhesive from the inlet port to the pans. The insert also includes an external hinge pin insert aperture configured to accept a hinge pin.

There is also provided a joint structure as described above, with the exception of the insert being configured to include a support wheel aperture and a support wheel that is located within the support wheel aperture.

### BRIEF DESCRIPTION OF THE DRAWINGS

The invention may be more completely understood by considering the detailed description of various embodiments of the invention which follows in connection with the accompanying drawings in which:

FIG. 1 is a top view of one embodiment of an insert of the present invention shown with linear members to be joined.

FIG. 2 is a perspective view of the insert shown in FIG. 1 with a linear member.

FIG. 3 is a top view of the insert shown in FIG. 1.

FIG. 4 is a front view of the insert shown in FIG. 1.

FIG. 5 is a side view of the insert shown in FIG. 1.

FIG. 6 is a back view of the insert shown in FIG. 1.

FIG. 7 is a bottom view of another embodiment of an insert of the present invention joining two linear members at an angle of 180°.

FIG. 8 is a perspective view of the insert shown in FIG. 1 where adhesive is indicated in shading.

FIG. 9 is a perspective view of yet another embodiment of an insert of the present invention.

FIG. 10 is a perspective view of the insert shown in FIG. 9 with two linear members.

FIG. 11 is a perspective view of the insert shown in FIG. 9 joining two linear members.

FIG. 12 is a perspective view of a decorative insert, shown with an added feature comprising a hinged aspect, joining two linear members.

FIG. 13 is a perspective view of a hidden insert that can be used in joining two linear members with an insert that comprises a support wheel used in operation of the unit containing the insert.

FIG. 14 is a perspective view of a decorative insert, shown with a support wheel used in operation of the unit containing the insert, joining two linear members.

While the invention is amenable to many modifications and alternative forms, specifics thereof have been shown by way of example in the drawings and will be described in detail. It should be understood, however, that the intention is not to limit the invention to the particular embodiment described. On the contrary the intention is to cover all modifications equivalents and alternatives following within the spirit and scope of the invention as defined by the appended claims.

### DETAILED DESCRIPTION

The present invention is believed to be applicable to a variety of systems for joining two hollow linear members to form a single joint structure. We have found that a structural joint between hollow members can be made using a joint insert or key designed to receive adhesive.

The key or insert is engineered to cooperate with a port formed in either or both of the hollow members such that a curable adhesive injected into the port is conducted by at least one channel to at least one adhesive pan or adhesive accumulation zone. The accumulation zones are engineered such that the adhesive bond formed in the zones are at positions to reinforce the joint structure. One or more channels can be engineered in conjunction with one or more pans or adhesive zones to provide a bonding interaction between the insert and the inside of the hollow member to reinforce the joint at all optimal areas of the joint.

The corner key structure of the invention can be used to join virtually any hollow member to a second similar or dissimilar hollow member in virtually any process involved in commercial or household real estate construction. Not only can the corner keys be used in the manufacture of fenestration components including windows and doors, the insert components can be used in any joinery aspect of any construction. The inserts can be used in primary framing by joining either extruded or metal hollow profiles into load bearing and partition wall framing. The insert structures can be used in forming roof trusses, floor substructures, concrete mold preparation and any other aspect of such construction adaptable to adhesive based assembly.

The insert or key has one or more surfaces that are held in close proximity to the internal structure of the hollow member. In these areas of close proximity, the adhesive pan or accumulation area can be engineered to accumulate the correct volume of adhesive. The channel and pan can be engineered such that the correct amount of adhesive is self-measuring. Under correct conditions of temperature and pressure, the insert key will accept only the required amount of adhesive and no more. Alternatively, the application time for the adhesive can be controlled such that the adhesive flows only for a sufficient period of time to fill the channels and pan. The insert or key structure is also conformed or engineered within the hollow members to fully seal the hollow structure such that water cannot penetrate the joint. We have found that these inserts or keys can be used to provide adequate structural integrity without secondary structural components such as metal fasteners or other reinforcement members.

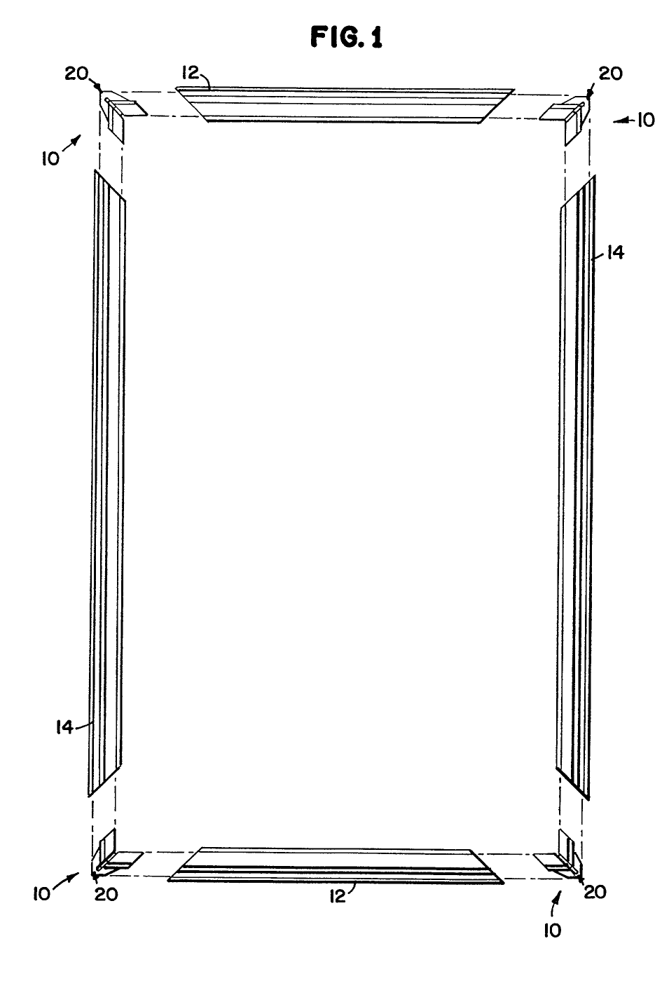

FIG. 1 illustrates one particular embodiment of a joint structure 10 of the present invention. Each joint structure 10 includes a first linear member 12, a second linear member 14, and an insert 20. As illustrated in FIG. 1, the joint structures 10 of the present invention may be used to join four hollow linear pieces in a rectangular product, such as a window sash.

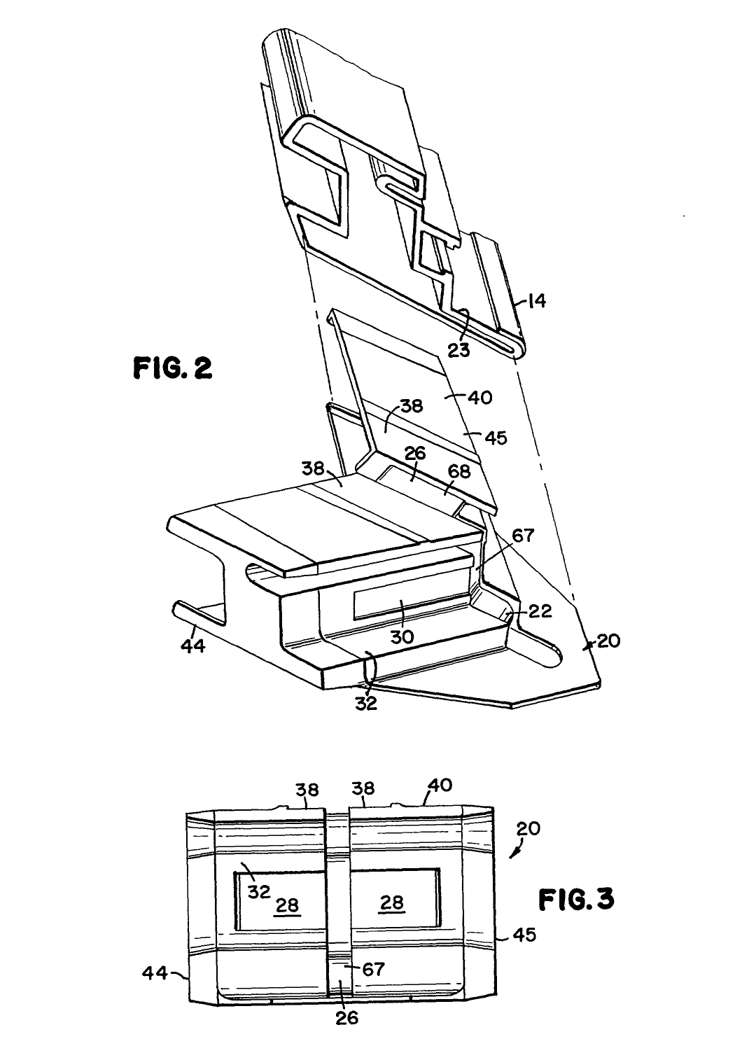

As shown in more detail in FIG. 2, each linear member, such as linear member 14, is at least partially hollow, and receives the insert 20 within its interior. Insert 20 is shown in detail in FIGS. 2-6 and includes a channel and pans for receiving adhesive to bond the components of the joint structure 10. The insert 20 includes two wing portions 44, 45, each wing portion being inserted into one of the linear members to be joined. One or both linear members will have an inlet port for receiving adhesive. In one embodiment, the location 22 of the inlet port is located along the joint line of the first and second linear members. The location 22 of the inlet port on the insert corresponds to location 23 on the linear member 14, where the inlet port will be formed.

The insert 20 includes a channel 26 for adhesive flow extending from the location 22 of the inlet port. The channel 26 is deep enough to allow the particular adhesive used to flow along the length of the channel easily. In one embodiment, the channel depth is about 0.070 inches to 0.090 inches, more particularly about 0.050 inches. Pans are located along the channel 26 where adhesive flow is desired. The pans are designed to be shallow recesses in the surface of the insert that will allow adhesive to cover the pan area, but not prevent further flow of the adhesive along the channel. The pans are considerably more shallow than the channel. Instead of being a defined recess in the surface of the insert, the pan may be a portion of the insert that is bordered by wall-like protrusions.

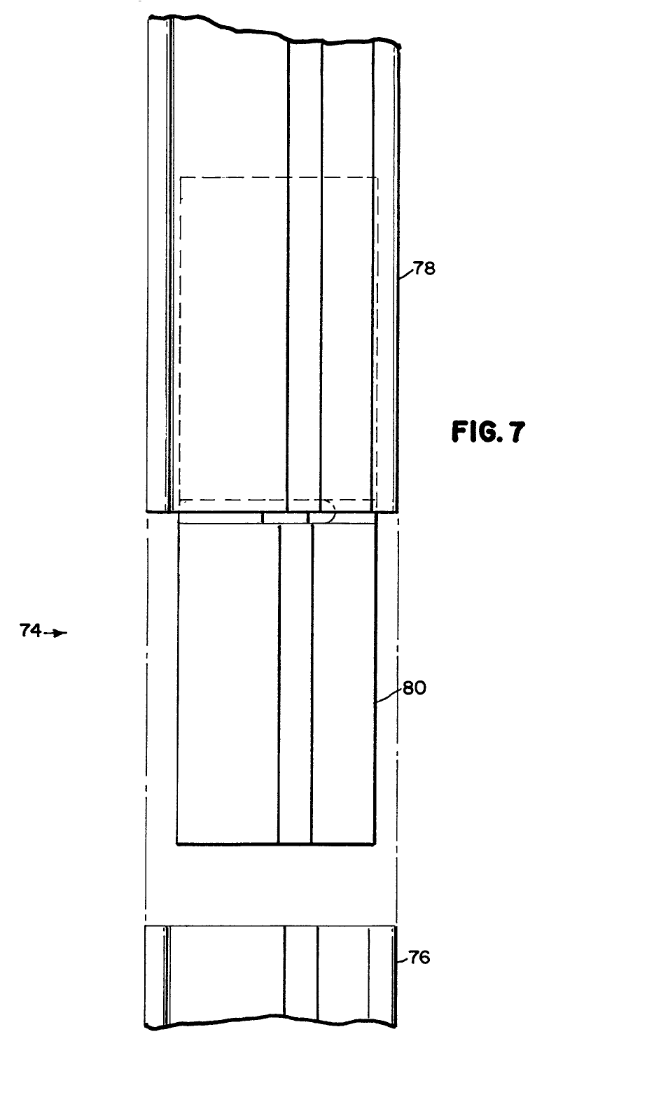

Now, referring to FIGS. 2-6 showing different sides of the insert 20, a first pair of pans 30 is formed near the location 22 of the inlet port on a top side 32. A second pair of pans 38 are located on a front side 40 of the insert 20, also adjacent to the channel 26. Now referring to FIG. 6 showing a back side 43 of the insert, the channel 26 continues to the location of the inlet port 22. A third pair of pans 42 are located adjacent to the channel 26 on the back side 43 of the insert 20 for receiving adhesive from the channel 26.

The channel 26 follows the outline of the insert body around the insert. When the linear members are joined using the insert, the channel will be adjacent to the joint line between the two linear members. Therefore, adhesive within the channel 26 will border the interior joint line, sealing the interiors of both linear members from the environment.

When a joint structure 10 is constructed, the two hollow linear members are fitted into place over the insert, such that the first linear member 12 receives the first wing 44 of the insert 20 and the second linear member 14 receives the second wing 45 of the insert 20. The insert 20 is designed so that it may be pushed into the linear members easily.

An inlet port is formed in one or both of the linear members. If the inlet port is located at the seam of the two linear members, the inlet port will be partially defined in both linear members so that it is centered within the joint structure. In the alternative, the inlet port could be formed before the insert is pushed into the linear members. However, it is preferable that the inlet be formed after the linear members are connected by the insert.

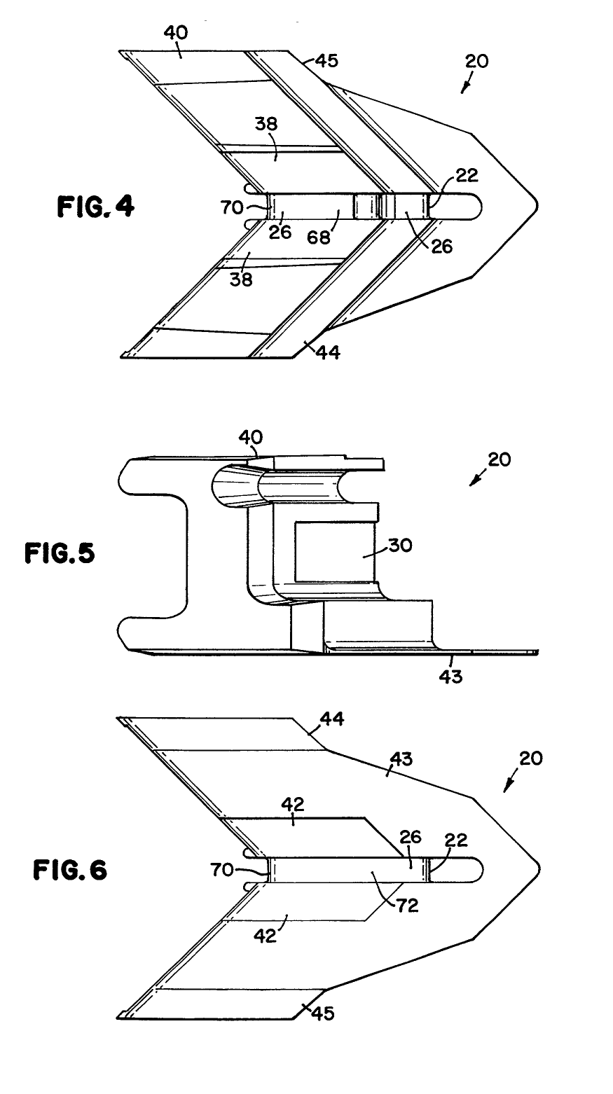

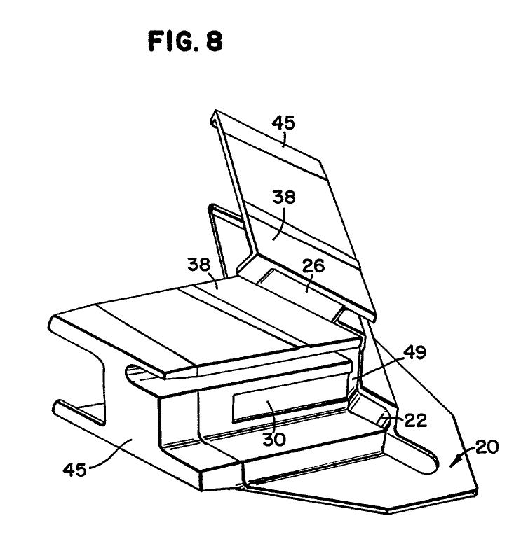

After the inlet port is formed, adhesive is injected into the inlet port and flows along the channel 26 and into the pans as shown by the shaded areas in FIG. 8. The adhesive flows down a top channel portion 67 and a back channel portion 72 simultaneously. The first and third pairs of pans 30, 42 will be filled with adhesive first, because of their proximity to the location 22 of the inlet port. The remainder of the channel 26 and the second pair of pans 38 adjacent to a front channel portion 67 will then be filled. The bottom channel portion 70, shown in FIG. 4, will also be filled with adhesive. The insert can comprise a molded inlet port 49 that can cooperate with the pans, channels and hollow members to distribute the adhesive to all areas for structural and sealing purposes.

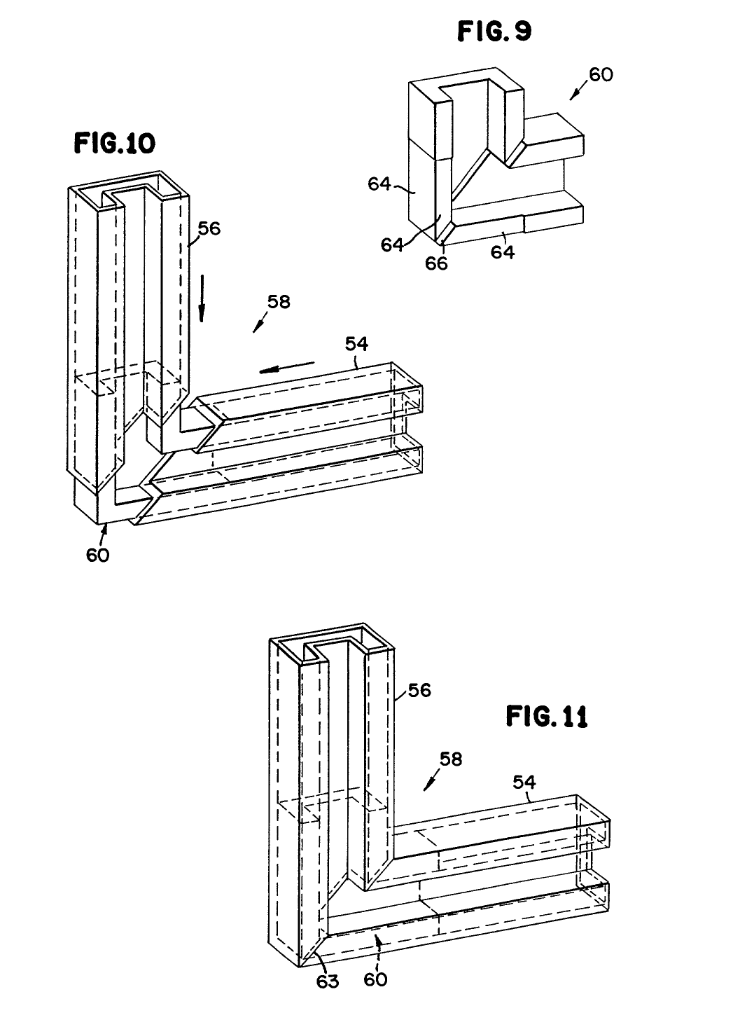

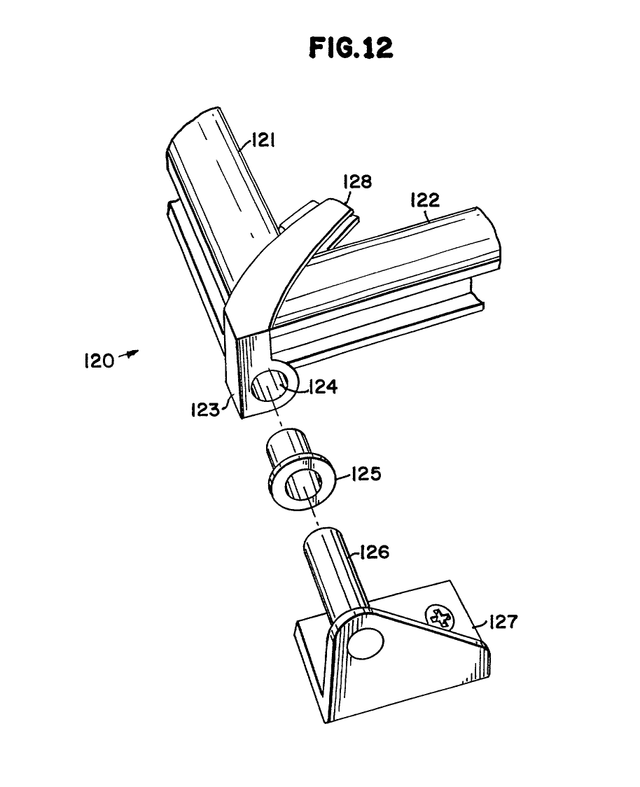

The channel locations, pan locations, and all dimensions of the insert depend on the application of the insert. An insert according to the present invention may be used with linear members of many different profiles, and the dimensions of the insert will vary accordingly. For example, an insert 60 designed for use in a joint structure 58 with first and second linear members 54, 56 with a simplified profile is shown in FIGS. 9-11. Channel 66 and pans 64 for adhesive are defined in the insert 60. An inlet port 63 is formed in one or both of the lineal members 54, 56. For example, as shown in FIG. 11, the inlet port 63 may be formed partially in both lineal members 54, 56 at their seam. Inserts of the present invention may be used with many other profiles also, depending on the structure to be assembled. For example, the joint structure 10 of FIGS. 1 and 2 may be used as a basement window sash construction.

While examples of corner joint constructions have been described, the insert of the present invention may also be used to form a joint of various other angles, including a straight joint structure as shown in FIG. 7. Two linear members 76, 78 may be joined using an insert 80. The linear members 76, 78 have an end cut at a 90° angle. In addition, the joint structure of the present invention may be used to connect members that are not entirely linear, as long as at least a portion of the member to be joined is linear and capable of receiving an insert.

FIG. 12 is a perspective view of the decorative insert, shown with an added feature comprising a hinged aspect, joining two linear members. In the structure 120 is shown a first linear member 121 joined to a second linear member 122 using the decorative insert 123. The decorative insert 123 comprises a decorative feature 128 and a hinge pin insert aperture 124. The aperture 124 is sized to fit a sleeve 125 into which is placed the hinge pin 126. The hinge pin 126 is mounted in a bracket 127 which is fastened to a wall not shown. FIG. 12 shows that the insert assembly technology of the invention can be used to incorporate both decorative features and functional features into the insert structure used in joining linear members.

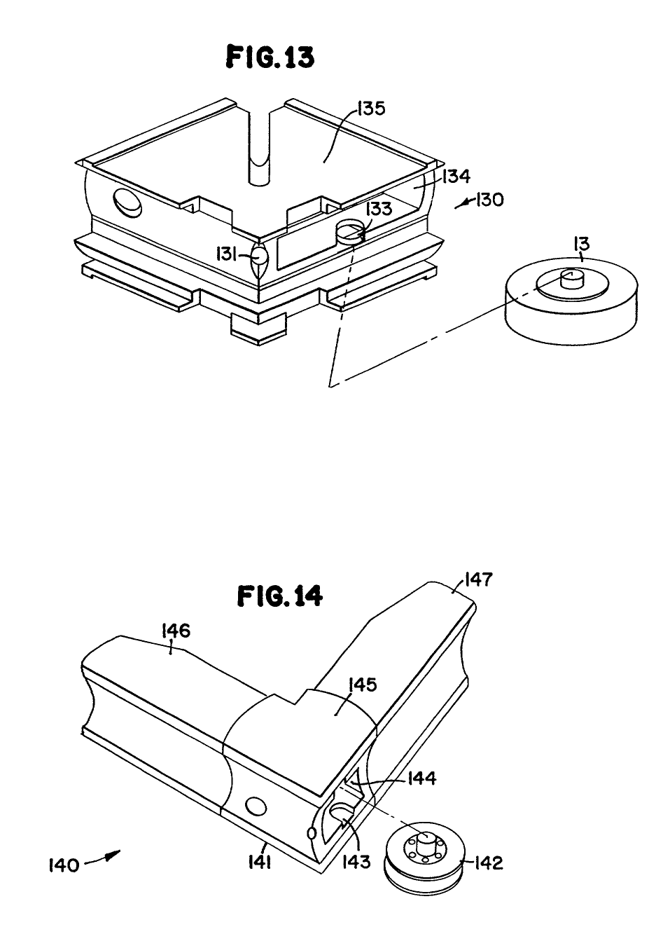

FIG. 13 shows a hidden insert used to join two linear members (each not shown). The insert 130 is shown with a support wheel 132. The support wheel 132 is mounted on a wheel mount 133 formed in the wheel well 134. The hidden corner key 130 is assembled with linear members not shown. The adhesive is introduced into port 131 which directs the adhesive to pan 135 comprising the entire exposed surface of the key. FIG. 13 shows that the corner key 130 of the invention can be entirely hidden within the joint structure except for a revealed functional feature comprising the wheel 132 mounted in the wheel well 134.

When used, the linear member containing the hidden key insert has premilled in the linear member, an aperture for the wheel 132 and the wheel well 134. The aperture is registered to the wheel well 134 such that after the assembly is complete, the wheel can simply be snap fit through the milled aperture in to the wheel well 134 and the mount 133.

FIG. 14 shows a different arrangement of elements in the insert containing a support wheel. In FIG. 14, an assembly 140 is shown with a first linear member 146 assembled with a second linear member 147 using a corner key wheel assembly 141. The assembly 141 is an insert in which the corner is revealed in the final assembly. Portions of the insert are introduced into the linear members 146 and 147 (not shown). The corner key 141 has a decorative aspect 145 forming the exterior of the unit corner assembly. The corner key 141 also has a functional feature comprising a wheel 142 mounted on a wheel support 143 formed in a wheel well 144. Using such an insert 141, the insert can have decorative and functional utility.

The composition and requirements of the components of the joint structure of the present invention will now be discussed. Before assembly of the joint structure 10, the linear members are cut to the proper length. The ends of the linear members may be prepared for joining by cutting the ends at a specified angle. For example, if the linear members will define an angle of 180° after assembly as shown in FIG. 7, the ends of the linear members will be cut at a 90° angle to the length. If a 90° angle will formed between the two linear members after assembly, the ends of the linear members should be cut at a 45° angle, as shown in FIG. 2. Possible methods of cutting the linear members include a power miter box, a contractor table saw, a radial arm saw or a tennoner modified by replacing blades with face mills and the drive chain with a servo-driven ball screw. In addition, many other methods of cutting are known in the art and may be applicable to the present invention. The dimensional tolerances of each method should be tested with the particular machinery that is used.

The linear members may be assembled entirely by hand, clamped into an assembly for assisting with proper alignment, or joined using any other method known in the prior art. In a preferred method where the linear members are being joined to form a window sash, the members, inserts and any other components may be placed in position around a sheet of glass or preassembled insulated glass unit having high E and argon gas filling or other improved units. The inserts may be fitted into the interiors of the linear members by hand. The window sash, now fitted together, is placed into a clamp assembly and the clamps are tightened. The clamps may exert a force against the joint assembly to ensure that the inserts and linears are firmly in place and are aligned. The applied force may act against each joint assembly in a direction at 45° to both of the linear members. The same force should be applied to each of the four inserts in a window sash assembly to ensure proper alignment.

The inlet port may be formed in either or both of the linear members to be joined to give access to the channel or channels of the insert. The placement of the inlet port may be chosen after considering the adhesive flow path, so that the adhesive will be able to reach all channels and pans where bonding is required. For the embodiment of the insert illustrated in FIGS. 2-6, the inlet port may be located on the linear member joint line, corresponding to location 22 on the insert. The adhesive will immediately travel simultaneously through the channels on the front and back of the insert, to fill first pans 30 and third pans 42. Location 22 for the inlet port corresponds to an opening at the seam of the first and second linear members, partially formed in each member. The inlet port may be formed using a hand held jig, or other machinery that is known in the art. The inlet port of this embodiment is preferably precisely located over the channel, and will be formed only in the linear member or members, not penetrating into the insert. The diameter of the port is preferably chosen to be large enough to allow easy insertion of the proper adhesive amount and the appropriate flow rate. The port may be approximately ⅛ to ½ inch in diameter, or more preferably about ⅛ to ¼ inch, and most preferably 3/16 inch in diameter.

In order to form the joint assembly of the present invention, the ends of the linear members will be capable of receiving the insert. These linear members may be hollow, partially hollow, or hollow only at the ends. Extruded linear members may be used with the present invention, which are generally hollow but may include ribs within the profile to add strength to the member. In some cases, portion of the ribs may be removed to accommodate the insert, or the insert may be designed to fit within the ribs. One example of a linear member that could be used with the present invention is an extruded polymer and wood composite material, described in U.S. Pat. No. 5,406,768.

When the dimensions of the insert are determined, a designer preferably considers the manufacturing tolerances of the profile of the linear members that will be joined. The insert should be designed to easily fit within the linear member, considering the possible variances in wall thickness. For example, in some cases where the method of U.S. Pat. No. 5,406,768 is used to produce linear members, wall thickness can vary by 0.020 inch. The insert dimensions may account for this type of variation.

Another consideration when designing the insert is the clearance between the insert and the interior walls of the linear members. The designer may allow for sufficient clearance for ease of assembly, but consider alignment and mechanical stability as well.

The insert may be made of materials known in the art that can withstand the stresses and deformations induced during assembly, shipment, installation and use of the finished product into which it is incorporated. Modeling may be employed to determine the stresses that the insert will need to withstand, and then a range of appropriate materials can be investigated. For many uses, polymers have sufficient tensile yield strength and toughness to function as an insert. Polymers that can be injection molded allow for a preferred method of manufacture. Some examples of polymers that may be used include injection molding grade PVC, ASA plastic, ABS plastics and Valox made by General Electric, Nylon 66, and other engineering resins. For a window sash application, a PVC marketed as VISTEL™ 9121 available from CONDEA Vista Co., Houston, Tex. 77079 has performed favorably. These materials are provided as examples that may be applicable to a specific insert application, but many other materials may also be appropriate. Preferably, the manufacturing tolerances of the insert are also considered when determining the dimensions of the insert.

### FLOWABLE HOT MELT ADHESIVE

In forming the bonded joints of the invention, a flowable hot melt adhesive is typically introduced into a port at the joint which is fluidly communicated with the channel or channels and the adhesive pans or defined adhesive volume areas. The preferred adhesive for use in this invention is a hot melt adhesive which is introduced into the joint at high temperature (typically about 100° C. to 220° C.). After introduction into the joint area, the adhesive solidifies either by cooling or through a curing or crosslinking reaction forming a tough reliable bond.

Preferred adhesives form a rigid structural bond between the insert or key and the hollow members. Further, the resulting structure should have sufficient strength to prevent failure in a cleaving mode destruction test and in a hanging mode destruction test. Further, the adhesive should also provide a sealing function to prevent air or water infiltration into the interior of the hollow members. Lastly, the adhesive should be sufficient to maintain an adequate structural bond while being exposed to extremes of other conditions including temperature, insulation and humidity.

Both relatively high temperature thermoplastics and curable thermosetting adhesives can find use in the application. Preferred adhesives have a relatively high melting point, typically greater than about 120° C. and typically with the range of about 110° C. to about 220° C. Such a high melting point allows for efficient application but obtains a high melting point bond that resists the effects of high temperature during periods of intense insolation, particularly in semi-tropical and tropical locations.

Preferred hot melt adhesives comprise a polyamide adhesive that is manufactured typically by the reaction of a dibasic acid and a diamine compound. Such polyamides often have a melting point that ranges from about 160° C. to 220° C. Dibasic acids typical for manufacturing such polyamide adhesives include dimeracid (dimerized fatty acids), dodecanedioic acid, sebacic acid, azelaic acid, adipic acid and aromatic acids such as terepthalic acid and napthlendioic acid. These acids can be reacted with amines such as ethylenediamine, hexamethylenediamine, diethylenetriamine, triethylenetetramine, dipiperidylpropane, polyoxypropylenediamine and other amino acids and lactam such as caprolactam, 11-aminoundecanoic acid, dodecalactam and others.

The resulting adhesives are characterized by a sharp melting point, excellent adhesion to composite substrates, excellent color with low odor, good moisture vapor barrier properties, good chemical and oil resistance and strong structural bonding. The polyamide material can be combined with tackifying resins, plasticizers and others including rosin tackifiers, dimerized rosin tackifiers, rosin ester tackifiers, rosin phenolic tackifiers, ketone resins, modified phenolic resins, malaic resin tackifiers, and plasticizers including para-toluenesulfonamide, n-ethylparatoluenesulfonamide, n-cyclohexylparatoluenesulfonamide, triphenylphosphate, tributylphosphate, phthalate esters, castor oil and other known materials.

Two or more part reactive or self-curing hot melt adhesives can also be used in the invention. Such adhesives are typically derived from two or more parts. Each part is melted and then combined in an applicator or glue gun which combines the hot melt streams at an appropriate volume ratio and applies the mixed homogeneous adhesive to the appropriate location in the joint area. The materials are formulated such that its melting points will be sufficiently high to provide good green strength within the joint upon cooling. Green strength is bond strength that occurs after the material is cool but before final crosslinking or curing reactions are complete.

Preferred hot melt adhesives in this area include epoxy and polyurethane adhesive materials. Epoxy adhesives typically operate by reacting an oxirane or epoxy group in an epoxy part with a compound having an active hydrogen compound typically an amine mercaptan carboxylic acid or hydroxyl or other similar compound having a reactive or active hydrogen moiety. Typical epoxy resins include bis-phenol A epoxy resins, epoxy novolak resins, high performance epoxy resins based on largely aromatic materials, flexible chain—long chain aliphatic epoxy resins, typically ether or ester based groups, and others well known in the art.

Typical curing agents for crosslinking with the epoxy or oxirane groups include mercapto compounds or polysulfides, amines, aliphatic amines, cycloaliphatic amines, aromatic amines, polyamides, dicyandiamide and others. Often, epoxy adhesives contain catalysts, diluents, fillers, elastomeric modifiers, and other materials. Further, polyurethane (isocyanate compound based) curable adhesives can also be used in the invention. The polyurethane adhesives are typically based on toluene diisocyanate (TDI), diphenylmethane-4,4′diisocyanate (MDI), polymethylenepolyphenylisocyanate (PAPI) and triphenylmethanetriisocyanate (Desmodur R) materials. Such reactive isocyanate compounds often are reacted with various polyester and polyether based glycols which react and crosslink to form a hard reliable joint. Polyurethane adhesives can be effective because the use of higher functionality polyurethanes can cause extensive crosslinking and high strength bonding.

Further, polyurethanes can form good high green strength bonds when appropriately formulated. Polyurethane adhesives can also be formulated with a variety of ingredients including polymeric materials to provide increased green strength, tackifiers and plasticizers as described above to improve the initial bond strength and flexibility of the adhesive material. Further, the adhesive can be combined with fillers and other materials for viscosity adjustment and stability.

Both epoxy and polyurethane adhesives have to be used carefully. The adhesives should be mixed and applied virtually instantaneously to avoid problems caused by the adhesive crosslinking and bonding within the application equipment. The viscosity of the hot melt thermoplastic or hot melt epoxy or polyurethane curable adhesives should remain between 700 and 30,000 cP, preferably between 7500 and 2000 cP at the application temperature. Preferred application temperatures typically range from about 120° C. to 220° C. using preferred application equipment.

The geometry or association of the port channel and pan of the structural joint area are typically matched to the melt flow characteristics of the adhesive material so that the adhesive, when applied to the port, rapidly flows through the channels into the pans with an appropriate amount of adhesive at a sufficient rate such that the pans are filled and not overflowed with adhesive material. The rate of injection can affect joint quality. If the adhesive is introduced too slowly, the adhesive can set too quickly, blocking flow and preventing adequate joint strength. Preferably, a measured amount of the adhesive is introduced into the joint quickly. Delivery of 5-25 grams, preferably 10-15 grams of the adhesive into the joint in a period of less than 20 seconds, preferably 1-15 seconds, is preferable. Injection temperature and pressure can be controlled to obtain required injection time and rate. Further, rapid application also increases productivity in an assembly line.

The modulus and elongation characteristics of the cured adhesive in the bond becomes important to obtain rigidity in the resulting assembly. The bond is typically tested in two modes. In a tensile mode where the joint is pulled apart by suspending the joint and applying a measured force to separate the joint at the joint line. Secondly, a cleavage type test can be applied to estimate the strength of the adhesive as the force is applied to the structure in a torsional mode around the adhesive joint. Both these properties are important for maintaining an adequate structural joint.

The behavior of the joint under tensile stresses in an operating temperature range is important for maintenance of integrity and shape of the sash at relatively low temperature (below 40° C.) and at relatively high temperature greater than about 80° C. to model common temperatures resulting from high insolation rates. The bond should be able to maintain the sustained load at high temperature of greater than 15 pounds in a tensile mode and to survive at temperatures cycled between −30° C. and 82° C. Examples of preferred adhesives for use in the structures of the invention include 3M's curable isocyanate adhesive TE030 and Bostic's thermoplastic copolyamide 4240 adhesive.

### EXPERIMENTAL

A number of 90 degree mitered frame corner joints similar to those shown in FIG. 1 were assembled from FIBREX® profiles and the insert (corner key) shown in FIGS. 2 through 6, and FIG. 8. The FIBREX® profiles were extruded using the disclosure of U.S. Pat. No. 5,406,768 whose teaching is hereby incorporated by reference. The inserts were injection molded PVC (M3800, available from GEON). The profiles were cut at 45-degree angles using a miter saw. Hot melt adhesive was metered through an inlet port positioned near location 22 of the insert, shown in FIG. 2. Adhesive flow rate was approximately 100 grams per minute, and adhesive was injected for about 15 seconds to fill the channel and pans shown in FIG. 8 with about 25 grams of adhesive. The assembled joints were allowed to cure for 72 hours at room temperature prior to testing.

Pull Test

The pull test was performed on an Instron Corporation Series IX Automated Materials Testing System equipped with a 5 kiloNewton load cell. The system operated at a crosshead speed of 1.27 millimeters per minute, a second crosshead speed of 0.046 millimeters per minute, and a data sampling rate of 10 data points per second. The test joints were securely clamped into the Instron with clamping fixtures uniquely adapted to the specific profile geometries under test. The pull test measured the extensional force required to pull the insert out of the adhesively bonded joint. Five (5) joints were tested. The average pull strength is reported in Table 1. The standard deviation for 3M-TE030 adhesive was ±170 Newtons (a value indicative of pull test variability generally).

Cleave Test

The cleave test measured the compressive force required to break the joint using a Urpan PR1 compression tester (100 bar) available from Urpan GmBH & Co. Maschinenban, Memmingen, DR. Five (5) test joints were prepared by cutting the profiles 135 millimeters from the outside edge of the joint with a miter saw. The test joint was oriented in the press with its “legs” (formed from the cut profiles) resting on the lower platen. Consequently, the apex comprising the outside corner of the joint was positioned 95 millimeters above the plane of the lower platen. The platens were slowly closed until the outside corner of the joint contacted the upper platen. The press was actuated and the maximum force registered in cleaving the joint at least half its length was reported as the cleave strength. The average cleave strength is reported in Table 1. The standard deviation for 3M TE030 adhesive was ±120 Newtons (a value indicative of cleave test variability generally).

TABLE 1

| | | | Pull | |
|---|---|---|---|---|
| | | | Strength | Cleave Strength |
| Adhesive | Adhesive Type | Supplier | (Newtons) | (Newtons) |
| TE030 | Polyurethane | 3M | 3,450 | 1,155 |
| | reactive hot | | | |
| | melt | | | |
| 4240 | Copolyamide | Bostik | >4,450 | 1,300 |
| 7239 | Copolyamide | Bostik | 3,295 | NA |
| HM 0652 | Polyamide | H. B. Fuller | 1,450 | NA |

The cleave strength of the adhesively bonded joint in about 4 times greater than a similar joint fastened with screws and about 2 times greater than similar joint that had been thermally welded.

The various embodiments described above are provided by way of illustration only and should not be construed to limit the invention. Those skilled in the art will readily recognize various modifications and changes that may be made to the present invention without strictly following the exemplary embodiments and applications illustrated and described herein, and without departing from the true scope of the present invention that is set forth in the following claims.

We claim:

1. A joint structure including an inlet port, comprising:
(a) a first linear member and a second linear member, each linear member defining hollow interiors at least at the ends of the linear members;
(b) an insert joining the linear members, proximate to the inlet port in the joint structure, the insert defining at least one channel proximate the inlet port, at least one pan formed in the insert associated with the first linear member, and at least one pan formed in the insert associated with the second linear member, the channel configured to permit flow of adhesive from the inlet port to the pans, the insert comprising an external hinge pin insert aperture configured to accept a hinge pin; and
(c) an adhesive forming a structural bond between the insert and the linear members at the channel and the pans.

2. The joint structure of claim 1 wherein the external hinge pin insert aperture is configured to accept a hollow sleeve into which the hinge pin fits.

3. The joint structure of claim 1 wherein the insert further comprises an external decorative portion.

4. A joint structure including an inlet port, comprising:
(a) a first linear member and a second linear member, each linear member defining hollow interiors at least at the ends of the linear members;
(b) an insert joining the linear members, proximate to the inlet port in the joint structure, the insert defining at least one channel proximate the inlet port, at least one pan formed in the insert associated with the first linear member, and at least one pan formed in the insert associated with the second linear member, the channel configured to permit flow of adhesive from the inlet port to the pans, the insert comprising a support wheel aperture and a support wheel located therein; and
(c) an adhesive forming a structural bond between the insert and the linear members at the channel and the pans.

5. The joint structure of claim 4 wherein the insert further comprises an external decorative portion.
